(19) United States
(12) Patent Application Publication
(10) Pub. No.: US 2021/0086385 A1
(43) Pub. Date: Mar. 25, 2021

(54) CUTTING MACHINE FOR CUTTING ELONGATED PRODUCTS, AND RELATED METHOD

(71) Applicant: Fabio Perini S.p.A., Lucca (IT)

(72) Inventors: Mario Gioni Chiocchetti, Capannori (IT); Romano Maddaleni, Bientina (IT)

(73) Assignee: Fabio Perini S.p.A., Lucca (IT)

(21) Appl. No.: 16/630,557

(22) PCT Filed: Jul. 16, 2018
(86) PCT No.: PCT/IB2018/055230

§ 371 Date: Jan. 13, 2020

(30) Foreign Application Priority Data
Jul. 18, 2017 (IT) 102017000081298

(51) Int. Cl. B26D 1/16; B26D 5/20; B26D 7/06; B26D 7/26; B26D 3/16

(52) U.S. Cl. CPC B26D 1/16; B26D 5/20; B26D 2007/013; B26D 7/2621; B26D 3/16; B26D 7/0683

(57) ABSTRACT

The cutting machine includes at least one feed path for elongated products, wherein the elongated products move forward along a direction substantially parallel to the longitudinal extension thereof. The cutting machine includes a rotating unit adapted to rotate around a rotation axis, carrying at least one first disc-shaped cutting blade and one second disc-shaped cutting blade. The rotation of the rotating unit causes an orbital movement of the first disc-shaped cutting blade and of the second disc-shaped cutting blade along trajectories intersecting the product feed path. The first disc-shaped cutting blade and the second disc-shaped cutting blade are offset from each other in a direction parallel to the product feed path. The first disc-shaped cutting blade and the second disc-shaped cutting blade are also angularly offset from each other with respect to the rotation axis of the rotating unit.

### TECHNICAL FIELD

Cutting machines and methods are disclosed for cutting rolls or so-called logs of wound paper, for instance tissue paper, for producing rolls of toilet paper, kitchen towels and the like.

### STATE OF THE ART

In many industrial fields rolls or logs of a continuous web material are produced, and then divided, by means of so-called cutting machines, into a plurality of logs of smaller axial dimensions. Typically, in the production of tissue paper rolls, for example rolls of toilet paper, kitchen towels and the like, a roll of great diameter (so-called parent reel) is processed into a plurality of rolls or logs, whose axial length is equal to the axial length of the parent reel and whose diameter is equal to the diameter of the rolls to be packed and sold to the end user. The logs are cut into a plurality of rolls by means of cutting machines, usually provided with one or more disc-shaped rotating blades.

U.S. Pat. No. 5,799,555 discloses a cutting machine for cutting tissue paper logs and producing rolls in fast sequence. This known machine comprises a rotating orbital head provided with a disc-shaped rotating blade.

In some cutting machines, for improving productivity two disc-shaped rotating blades are provided, arranged at diametrically opposite positions. U.S. Pat. No. 4,041,813 discloses, for example, a cutting machine with a head or orbital gib rotating around a substantially horizontal axis. The head carries two disc-shaped rotating blades that are diametrically opposite, i.e. arranged at opposite positions with respect to the rotation axis of the head. Two cuts of the log are therefore performed at every rotation of the head.

US 2006/0000312 discloses a cutting machine provided with a rotating plate, on which three disc-shaped rotating blades are arranged equidistant, for further increasing productivity.

U.S. Pat. No. 8,037,794 discloses a cutting machine provided with a rotating head supporting two pairs of disc-shaped rotating blades. Each pair of disc-shaped rotating blades is constituted by two coaxial blades arranged at an adjustable reciprocal axial distance. In this way, it is possible to perform four cuts of the log at every rotation of the head. The machine disclosed in this publication has high productivity and allows to adjust the distance of the disc-shaped coaxial blades based on the axial dimension of the rolls to be produced. However, in some cases the machine can have some drawbacks, due to the fact that the two coaxial blades act on the single log simultaneously. This can cause a compressive deformation of the material of which the log is made, with consequent damages to the finished product. This is due to the fact that the disc-shaped cutting blades of these machines have a bi-conical shape, whose thickness increases from the periphery towards the center. Above all when the blade diameter is reduced due to wear, the thickness of the blade is not negligible and, when penetrating the material to be cut, the blade axially presses it. This is a problem especially in the case of rolls wound around tubular winding cores, made for example of cardboard, as the winding cores may be irreversibly deformed due to compression, with consequent scraps production. A further inconvenience is that replacing the worn blades, especially the internal ones, is complex and difficult.

There can be similar needs also when cutting other types of articles or products that are elongated in an axial direction, which shall be divided into products with smaller axial dimension.

A need therefore exists for providing a machine and a method for cutting logs or rolls of wound web material, for example tissue paper logs, in particular tissue paper wound on cardboard cores, or other elongated products, that partially or completely overcome the drawbacks of the known machines, ensuring at the same time high productivity.

### SUMMARY

According to one aspect, a cutting machine is disclosed for cutting elongated product, comprising a feed path for the products to be cut. The feed path may be single or multiple, i.e. a system can comprise only one feed channel for moving the products, aligned longitudinally one after the other, or two or more channels, adjacent to one another, for moving simultaneously more products in parallel, the products being, if necessary, offset with respect to one another in longitudinal direction. The products move along the feed path in a direction substantially parallel to their longitudinal extension.

Feed members for feeding the products are also provided along the feed path. In case of a multiple feed path, for example a path with a plurality of parallel adjacent channels, the feed members may be so configured as to move a plurality of products forward, if necessary offset with respect to one another in longitudinal direction, i.e. in feeding direction.

The machine may also comprise a unit rotating around a rotation axis. The rotating unit may carry at least a first disc-shaped cutting blade and a second disc-shaped cutting blade. The first disc-shaped cutting blade and the second disc-shaped cutting blade have the respective rotation axes parallel to each other and which can be substantially parallel to the rotation axis of the rotating unit. In other embodiments, the rotation axes of the disc-shaped cutting blades may be skewed with respect to the rotation axis of the rotating unit.

The rotation of the rotating unit around the rotation axis causes an orbital movement of the first disc-shaped cutting blade and of the second disc-shaped cutting blade along substantially parallel trajectories intersecting the feed path of the products.

Advantageously, the first disc-shaped cutting blade and the second disc-shaped cutting blade are offset from each other in a direction parallel to the rolls feed path and parallel to the rotation axis of the rotating unit. Consequently, the trajectories of the two disc-shaped rotating blades may lie on two substantially parallel planes, offset from each other along the axial direction, i.e. the direction defined by the rotation axis of the rotating unit.

The first disc-shaped cutting blade and the second disc-shaped cutting blade may be also angularly offset from each other with respect to the rotation axis of the rotating unit. Due to the angular offset between the two disc-shaped cutting blades, the blades interact with the product to be cut in staggered manner, i.e. one of the two disc-shaped rotating blades at least partially starts cutting and finishes cutting in advance with respect to the cut operation performed by the other disc-shaped rotating blade.

It is possible, for example, to set such an angular offset of the two disc-shaped cutting blades such that the second disc-shaped cutting blade starts cutting the product when the first disc-shaped cutting blade has already cut, partially or completely, the product. In this way, the compressive deformation of the material of which the product is made, due to the thickness of the disc-shaped cutting blades, is reduced with respect to the case where the two disc-shaped cutting blades are coaxial, as in the prior art machines. In this latter case, the two coaxial blades simultaneously penetrate the product, causing the compression of the material of which it is made, to an extent proportional to the thickness of the two disc-shaped cutting blades. The angular offsetting of the disc-shaped cutting blades results in a staggered action of the two disc-shaped cutting blades on the products, and therefore in a reduced crushing of the material of which the product is made following the penetration of the disc-shaped cutting blades therein.

In some embodiments, the feed members may comprise pushing members carried by continuous flexible members, for example belts or chains. If only one feed channel is provided, along which the products to be cut move forwards sequentially one after the other, a single flexible member is enough, to which one or more pushing members are fixed. If the feed path comprises two or more parallel adjacent channels, it could be useful to provide a plurality of motors for moving the products forwards in the single channels in an axially offset manner.

In some embodiments, for example, a continuous flexible member for each channel can be advantageously provided, and one or more pushing members may be fastened on each continuous flexible member. Each flexible member may be provided with a motor, independent from the motors of the other flexible members. The motors can be controlled by a single central control unit, imparting, to the products in the single channels, a staggered forward movement from a channel to another. This allows to start the forward movement of each product in the respective feed channel as the disc-shaped cutting blades have exited from the product, even if the cut of the products in the adjacent channels has not been yet completed or done.

Each disc-shaped cutting blade can rotate around a rotation axis that can be substantially parallel to the main rotation axis, around which the rotating equipment rotates.

In some embodiments, the first disc-shaped cutting blade and the second disc-shaped cutting blade are offset from each other by an angle comprised between 5° and 120°, preferably between 10° and 90°, more preferably between 15° and 45°, for example between 20° and 45°. The offset angle between the disc-shaped cutting blades may be fixed or adjustable. This allows, for example, to adapt the machine configuration to the diameter of the products to be cut and/or to the number of adjacent parallel channels, along which the products move forward.

Such a machine is particularly advantageous for cutting wound paper logs, for example logs of tissue paper, for producing rolls of toilet paper, kitchen towels and the like. In fact, these rolls are very delicate and can be damaged if excessively compressed by the cutting blades in axial direction. Moreover, these rolls are usually formed around tubular winding cores, often made of cardboard or plastic. The tubular winding cores may be damaged by the compression due to the simultaneous penetration of two disc-shaped cutting blades into the log to be cut. For example, the tubular winding cores may be crushed thus reducing the hollow space inside the roll. With the two disc-shaped cutting blades arranged axially and angularly offset as described above, it is possible to reduce the compressions in axial direction of the material of which the log is made, thus reducing the risks of producing rejects.

In some embodiments, the offset of the first disc-shaped cutting blade and of the second disc-shaped cutting blade in the feed path direction can be adjusted, to have cut products of different axial length.

In some embodiments, the first disc-shaped cutting blade and the second disc-shaped cutting blade can be carried by a first arm and by a second arm, respectively. The first arm and the second arm may be adapted to rotate integrally with each other around the rotation axis. The first arm and the second arm may also be coupled together by means of an elongation mechanism transmitting the rotation between the first arm and the second arm and allowing to vary the distance between the first arm and the second arm parallel to the rotation axis.

The machine may comprise an actuation shaft for actuating the first disc-shaped cutting blade and the second disc-shaped cutting blade. The actuation shaft may be supported in the first arm and in the second arm. In some embodiments, a first drive may be provided for transmitting the rotation motion from the actuation shaft along the first arm to the first disc-shaped cutting blade. A second transmission may be further provided for transmitting the rotation motion from the actuation shaft along the second arm to the second disc-shaped cutting blade. Each transmission can comprise, for example, a flexible member, such as a chain or preferably a belt, for example a toothed belt.

In some embodiments, the shaft for actuating the first disc-shaped cutting blade and the second disc-shaped cutting blade may be supported inside a hollow drive shaft, which is torsionally connected to the first arm. In this way, the hollow drive shaft, connected for example to a first actuation motor, drives the first arm in rotation and the first arm drives the second arm in rotation through a mechanical coupling. The two arms rotate integrally around the rotation axis and make the two disc-shaped cutting blades follow the respective trajectories. The actuation shaft, supported rotatable through the hollow drive shaft, may be mechanically coupled to a second actuation motor, which drives the actuation shaft in rotation, and, through the respective transmissions, makes the two disc-shaped cutting blades rotate while orbiting along the respective trajectories.

The hollow drive shaft can be supported in a sleeve, movable orthogonally to the product feed path so as to move towards, and away from, the feed path. In this way, the trajectories, along which the first disc-shaped cutting blade and the second disc-shaped cutting blade orbit, may be moved towards, or away from the feed path, for example in order to recovery the wear of the disc-shaped cutting blades due to the grinding thereof. The gradual movement of the orbital trajectories of the disc-shaped cutting blades towards the product feed path may be obtained also with other suitable mechanisms, adapted to move the rotation axis of the rotating unit, on which the disc-shaped cutting blades are mounted, towards the feed path of the products to be cut.

To achieve a better cut, in terms of quality, a holding device for the products can be arranged along the product feed path, adapted to hold the products laterally or externally during cutting. The holding device can comprise three holding members arranged in sequence along the feed path, between which two passages or spaces are formed for the first disc-shaped cutting blade and for the second disc-shaped cutting blade, respectively. An intermediate holding member can be provided between an upstream holding member and a downstream holding member, with respect to the product feeding direction along the feed path.

The intermediate holding member may have an axial dimension, i.e. a dimension parallel to the product feeding direction, which is adjustable according to the distance in axial direction of the two disc-shaped cutting blades, i.e. according to the distance of the trajectories along which the two disc-shaped cutting blades orbit. This distance depends on the axial dimension of the articles obtained by cutting the elongated products moving forward along the feed path. In the case of logs and rolls obtained from the cut of the log, the distance depends on the axial dimension of the rolls to be obtained. The lengthening or shortening of the intermediate holding member results in the change, in axial direction, of the distance between the two passages for the first disc-shaped cutting blade and for the second disc-shaped cutting blade, defined by the holding member.

For example, in some embodiments the intermediate holding member can be made of two telescopic portions, at least one of which is movable parallel to the feed path. The upstream holding member or the downstream holding member can be integral with one of the two telescopic portions of the intermediate holding member. In some embodiments, the upstream holding member is integral with one of the two telescopic portions of the intermediate holding member, whilst the downstream holding member is integral with the other telescopic portion of the intermediate holding member.

According to a further aspect, disclosed herein is a method for cutting products having a first length into products having a second length, the first length being greater than the second length. The products to be cut can be, for example, logs of paper, for instance tissue paper. The products obtained by cutting can be rolls or small rolls of toilet paper, kitchen towels or the like. In embodiments disclosed herein, the method comprises the following steps: moving forward at least one product along a feed path in a direction substantially parallel to the longitudinal extension of the product; moving a first disc-shaped cutting blade and a second disc-shaped cutting blade around a rotation axis along respective orbital trajectories intersecting the feed path, the first disc-shaped cutting blade and the second disc-shaped cutting blade being angularly offset from each other with respect to the rotation axis and the two orbital trajectories being axially offset from each other along the rotation axis in order to perform two cuts of an elongated product at every rotation of the disc-shaped cutting blades around the rotation axis.

In embodiments of the method disclosed herein, the blades rotate integrally with each other along the orbits, and the orbits are preferably equal to each other. The orbits may be elliptical or, preferably, circular.

In some embodiments, the first disc-shaped cutting blade and the second disc-shaped cutting blade are offset from each other by an angle comprised between 5° and 120°, preferably between 10° and 90°, more preferably between 15° and 45°.

In possible embodiments of the method disclosed herein, the first disc-shaped cutting blade and the second disc-shaped cutting blade are angularly offset from each other by such an angle that, for at least a portion of the orbital motion thereof, both the blades are engaged in the products.

In particular, when the products to be cut are logs wound on tubular winding cores, the disc-shaped cutting blades are preferably so offset that, when cutting a log, at each instant only one of said first disc-shaped cutting blade and second disc-shaped cutting blade is engaged in the tubular winding core. In this way, the tubular winding core is not excessively pressed.

In a known manner, the products to be cut can move forward with continuous or intermittent motion along the feed path. In case the forward movement is continuous, it can be at constant or, preferably, variable speed, so that feeding occurs at lower speed when the blades are engaged in the product to be cut and, vice versa, at greater speed when the blades are not engaged in the product to be cut.

In some embodiments of the method described herein, the disc-shaped cutting blades are axially offset by a length equal to the second length of the cut products, i.e. for example a length equal to the axial dimension of the rolls obtained by cutting the log; at every rotation of the disc-shaped cutting blades along the trajectories, the product to be cut moves forward by one step equal to twice the second length.

In other embodiments of the method disclosed herein, the disc-shaped cutting blades are axially offset by a length equal to the triple of the second length, i.e. for example of the axial length of the rolls obtained by cutting the log; at every rotation of the disc-shaped cutting blades along the trajectories, the product to be cut move forward by a step equal to twice the second length.

By arranging the blades offset from each other by an angle smaller than 180°, there is advantageously more time for moving the products to be cut forward between a cutting operation and the following one. In the prior art machines, providing for a rotating unit on which two disc-shaped cutting blades are arranged offset from each other by 180° with respect to the rotation axis of the rotating unit, the time for moving forward the product to be cut between a cut and the subsequent one is relatively short. On the contrary, with two blades that are angularly nearer to each other and axially offset from each other, it is possible, on one hand, to perform two sequential cuts or two almost overlapping and axially offset cuts, so that the members for moving forward the logs, or other products to be cut, have much time for moving the products forward up to the subsequent pair of cuts.

In this way a machine can be provided with high productivity and reduced inertial stresses, thanks to the fact that it is not necessary to impart too high accelerations to the products to be cut.

### BRIEF DESCRIPTION OF THE DRAWINGS

The invention shall be better understood by following the description and the accompanying drawing, which show a non-limiting example of embodiment of the invention. More in particular, in the drawing:

FIG. 1 is a side view and partial cross-section of a cutting machine according to one embodiment;

FIG. 2 is a front view according to II-II of FIG. 1;

FIG. 3 is view according to III-III of FIG. 1;

FIG. 4 is a diagram illustrating the operation of the holding members of the products to be cut;

FIG. 5 is a side view and partial cross-section of a modified embodiment of the cutting machine;

FIG. 6 is a diagram of the cutting step of a log of paper wound around a tubular winding core;

FIGS. 7 and 8 are diagrams illustrating two possible cutting modes.

### DETAILED DESCRIPTION OF EMBODIMENTS

The detailed description below of example embodiments is made with reference to the attached drawing. The same reference numbers in different drawings identify equal or similar elements. Moreover, the drawings are not necessarily to scale. The detailed description below does not limit the invention. The protective scope of the present invention is defined by the attached claims.

In the description, the reference to “an embodiment” or “the embodiment” or “some embodiments” means that a particular feature, structure or element described with reference to an embodiment is comprised in at least one embodiment of the disclosed subject matter. The language “in an embodiment” or “in the embodiment” or “in some embodiments” in the description do not therefore necessarily refer to the same embodiment or embodiments. The particular features, structures or elements can be furthermore combined in any suitable way in one or more embodiments.

In the description below, specific reference will be made to a cutting machine for cutting logs of tissue paper for forming rolls of toilet paper, kitchen towels and the like. Features described herein can be advantageously used also for producing cutting machines for cutting other products, where similar problems can occur.

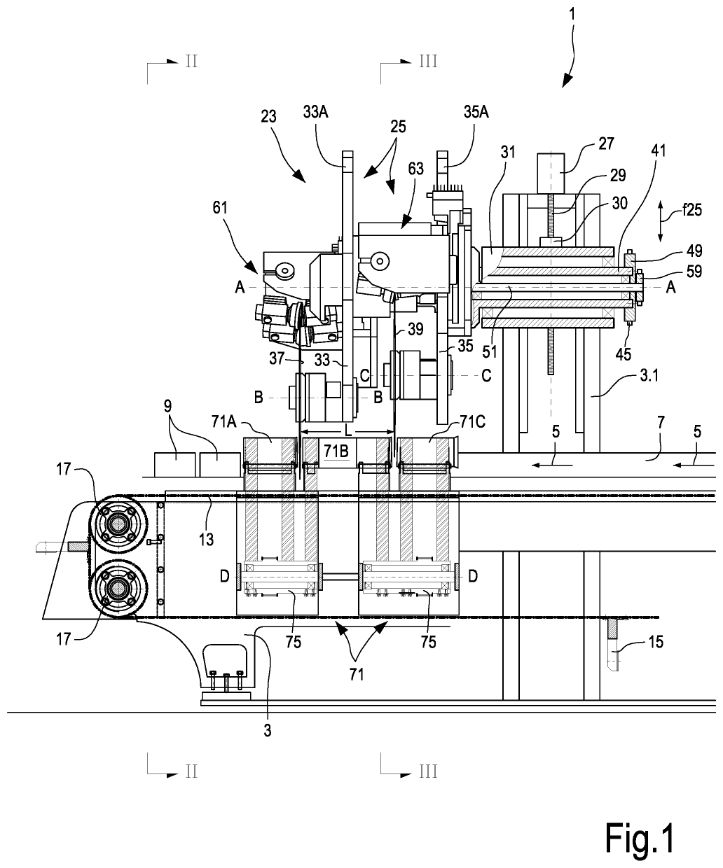

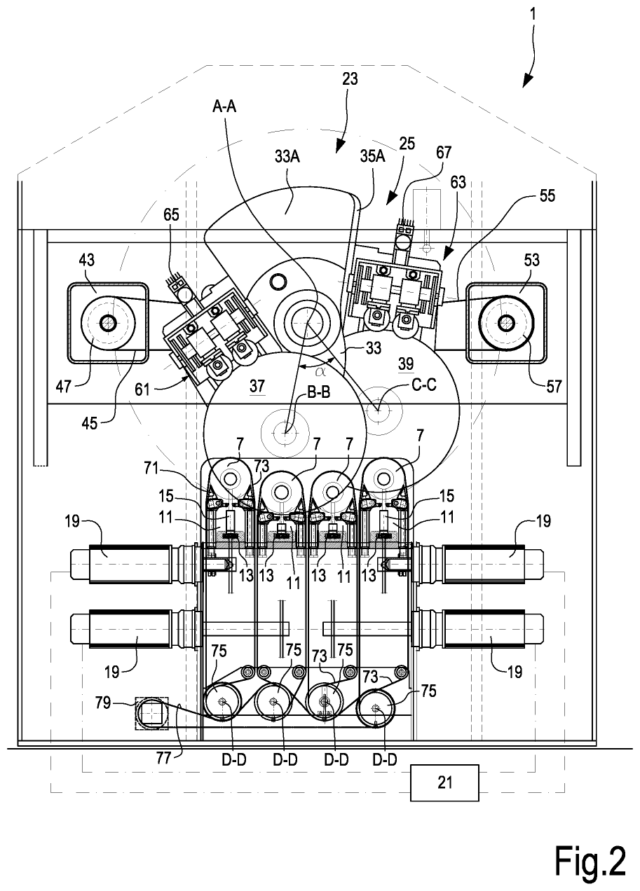

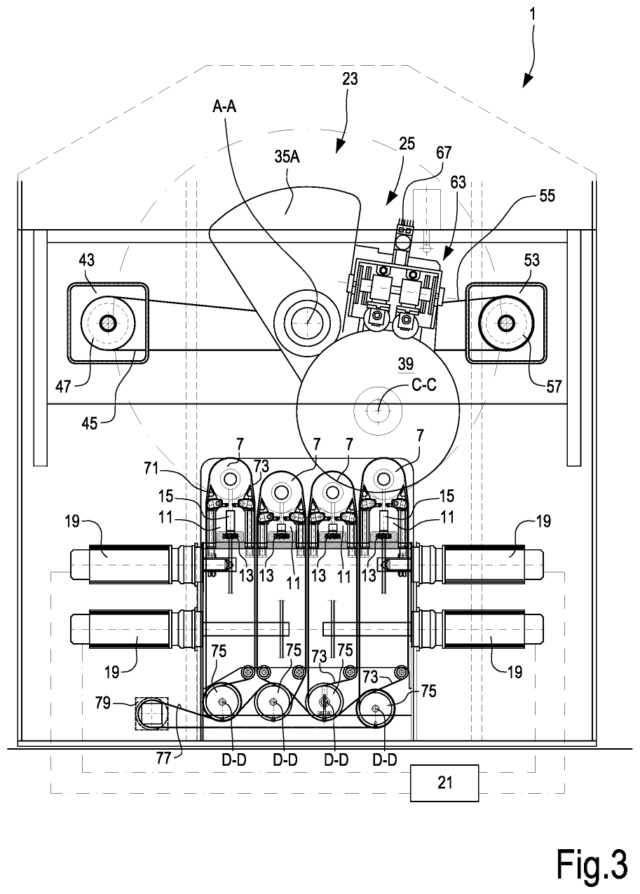

In FIG. 1 a cutting machine 1 is partially shown. In the illustrated embodiment, the cutting machine 1 comprises a bearing structure 3, on which a feed path 5 for the products to be cut is provided. A product to be cut 7, for example a log of tissue paper or the like, is divided into single rolls 9 that are then moved towards a station where the head and tail trimming are removed, and then to a packing station, both the stations being not shown. As illustrated in detail in FIG. 2, the feed path 5 actually comprises a plurality of feed channels 11. In the illustrated example, four feed channels 11 are provided, adjacent and substantially parallel to one another.

A feed member for respective logs 7 may be associated with each feed channel 11. In the illustrated embodiment, each feed member comprises a continuous flexible member 13, for example a belt or a chain. Along the continuous flexible member 13 pushing members 15 are provided at suitable distance, to push each log 7 from the back along the feed path 5. Each continuous flexible member 13 is driven around wheels 17, two of which are shown in FIG. 1. In practical embodiments, in the end part of the cutting machine 1, not shown in FIG. 1, two more wheels 17 can be provided for each flexible member 13.

In some embodiments, each flexible member 13 of each feed channel 11 can be controlled by a respective motor 19 (see FIG. 2). The motors 19 can be controlled by a central control unit, schematically indicated with 21, so as to move forward each log 7 in the respective feed channel 11 with independent motion for the four feed channels 11, for the purposes better explained below.

The cutting machine 1 comprises a cutting head 23 suitably supported by the bearing structure 3, for example by a substantially vertical portion 3.1 of the bearing structure 3. The cutting head 23 can comprise a rotating unit 25 rotating around a rotation axis A-A, which can be substantially horizontal and substantially parallel to the feed path 5 of the logs 7 to be cut. The rotating unit 25 may be movable according to the double arrow f25 in substantially vertical direction along the portion 3.1 of the bearing structure 3, for the purposes better described below. The motion according to the double arrow f25 allows to move the rotating unit 25 and the rotation axis A-A thereof selectively towards and away from the feed path 5 of the logs 7 to be cut.

The movement according to double arrow f25 can be controlled by an actuator 27, for example an electric motor, by means of a threaded bar 29 and a nut screw 30. This latter can be integral with a sleeve 31 or other element supporting the rotating unit 25. The upward and downward movement of the rotating unit 25 according to the double arrow f25 can be also imparted by a different driving system, for example by means of a motor and a belt or a chain, a cylinder-piston actuator, a pinion-rack mechanism or any other suitable mechanism. The upwards and downward movement of the rotating unit 25 can be preferably controlled by the central control unit 21.

The rotating unit 25 comprises a first arm 33 and a second arm 35. The first arm 33 carries a first disc-shaped cutting blade 37, rotating around a rotation axis B-B. The second arm 35 carries a second disc-shaped cutting blade 39, rotating around a rotation axis C-C. The rotation axes B-B and C-C can be parallel to each other and parallel to the rotation axis A-A of the rotating unit 25.

As shown in particular in FIG. 2, the two disc-shaped cutting blades 37 and 39 are angularly offset with respect to the rotation axis A-A of the rotating unit 25. In FIG. 2, the two disc-shaped cutting blades 37 and 39 are offset by an angle α. In some embodiments, the angle α can be comprised, for example, between 5° and 120°. In embodiments described herein, the angle α is comprised between 10° and 90°. Angles comprised between 15° and 45°, or between 20° and 45° are presently preferred.

As shown in FIG. 1, the first disc-shaped cutting blade 37 and the second disc-shaped cutting blade 39 are offset also in axial direction, i.e. parallel with respect to the rotation axis A-A of the rotating unit 25, and are on two substantially parallel planes, orthogonal to the axes A-A, B-B, C-C and spaced by an adjustable distance L, as described below.

The rotating unit 25 can be driven into rotation by a hollow drive shaft 41, which in turn is driven by a motor 43 through a belt 45 (see FIG. 2). The belt 45 can be entrained around a drive pulley 47 actuated by the motor 43 and around a driven pulley 49 keyed on the hollow drive shaft 41 (see FIG. 1).

The hollow drive shaft 41 can be supported inside the sleeve 31 and can be constrained torsionally to the rotating unit 25.

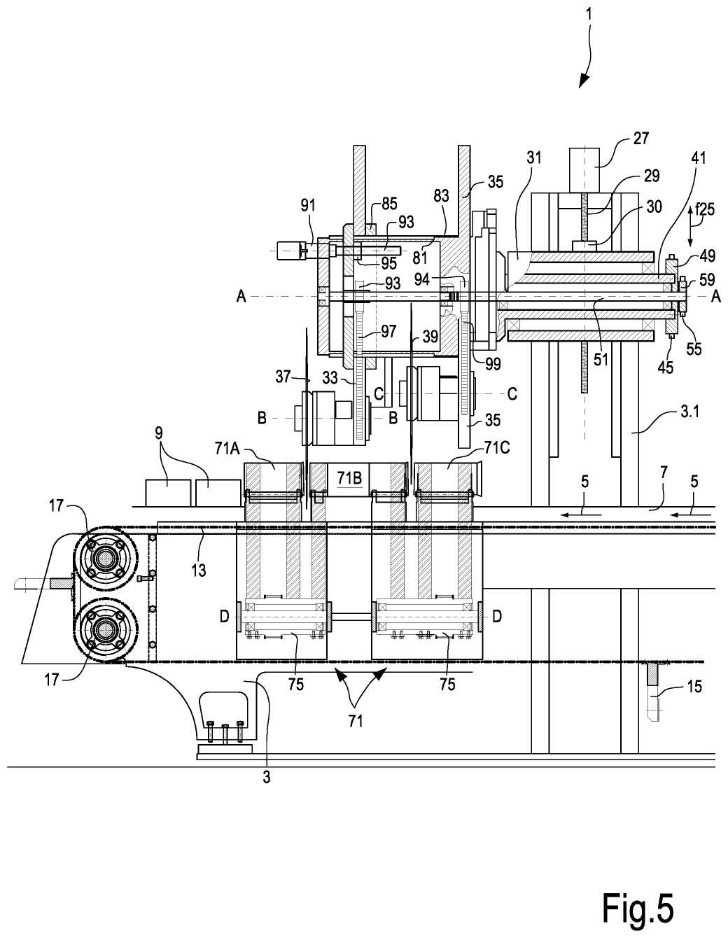

Inside the hollow drive shaft 41 a further drive shaft 51 can extend, taking motion from a second motor 53, for example through a belt 55, entrained around a drive pulley 57 and a driven pulley 59. The second drive shaft 51 transmits motion to the first disc-shaped cutting blade 37 and to the second disc-shaped cutting blade 39, for example through toothed belts, chains, gears or other transmission means. A constructive solution for transmitting rotation to the disc-shaped cutting blades 37 and 39 will be described in greater detail below with reference to FIG. 5.

The motorization system of the disc-shaped cutting blades 37 and 39 can be configured differently from what described above, for example providing motors directly coupled with the respective shafts 41 and 51 or motors actuating respective output gears engaging toothed gears keyed on the shafts 41 and 51.

In some embodiments, the arms 33 and 35 can be provided with suitable counterweights 33A and 35A.

In the present description, the term “arms” 33 and 35 refers to any mechanical structure adapted to support the disc-shaped cutting blades 37 and 39 so as to make them orbit along trajectories centered on the rotation axis A-A.

A grinding unit can be associated with each disc-shaped cutting blade 37, 39. In particular, in FIG. 2 number 61 indicates a grinding unit for the disc-shaped cutting blade 37 and number 63 indicates a grinding unit for the disc-shaped cutting blade 39. The grinding units 61 and 63 may be provided with a suitable number of grinding wheels, for example two or four grinding wheels for each grinding unit. The grinding units 61 and 63 may also be movable according to a radial direction with respect to the rotation axis of the corresponding disc-shaped cutting blade 37, 39. In this way, each grinding unit 61 and 63 can be brought alternatively into a work position, where the grinding wheels are in contact with the respective disc-shaped cutting blade, and into an idle position. The radial movement also allows to recover wear of the respective disc-shaped cutting blade due to the subsequent grinding operations. Numbers 65 and 67 generically indicate two actuators controlling the radial movement towards and away of the respective grinding unit 61, 63.

According to some embodiments, in the area of the feed path 5 where the first disc-shaped cutting blade 37 and the second disc-shaped cutting blade 39 act, external holding members for the logs 7 to be cut can be provided. The holding members form, as a whole, a holding device 71. The function of the holding device 71 is to hold the logs 7 during cutting, so that the thrust generated by the disc-shaped cutting blades 37 and 39 orthogonally to the axis of the logs 7 do not move the logs outside the feed path 5.

In some embodiments, the holding device 71 may comprise, along each feed channel 11 of the feed path 5, three holding members indicated with 71A, 71B, 71C and arranged in sequence. Between each pair of consecutive holding members a gap or passage is defined, through which one or the other of the two disc-shaped cutting blades 37 and 39 can pass. More in particular, between the holding member 71A and the holding member 71B a gap is provided, through which the disc-shaped cutting blade 37 can pass, whilst between the holding member 71B and the holding member 71C a gap is defined, through which the disc-shaped cutting blade 39 can pass.

Each holding member 71 may be designed in various ways, one of which is illustrated, just by way of example, in FIGS. 1, 2 and 4. The holding members 71 may comprise flexible elements 73 anchored to rotating drums 75. The rotating drums 75 can be driven in rotation around respective axes D-D through a belt 77 that can be actuated by a motor 79. The rotation of each drum 75 in reciprocating direction by a suitable angle causes a traction and a loosening of the respective belts 73, which therefore cause the holding of the logs 7 during cutting and the release thereof to allow the forward movement thereof between a cut and the subsequent cut. In an alternative configuration, an independent motor 79 can be provided to drive in rotation each drum 75 around the respective axis D-D so as to release the members 71 independently for each feed channel 11. With this configuration, it is possible to optimize the times for the forward movement of the pushers 15 of each channel 11, moving them as the second cut on the log 7 has been performed.

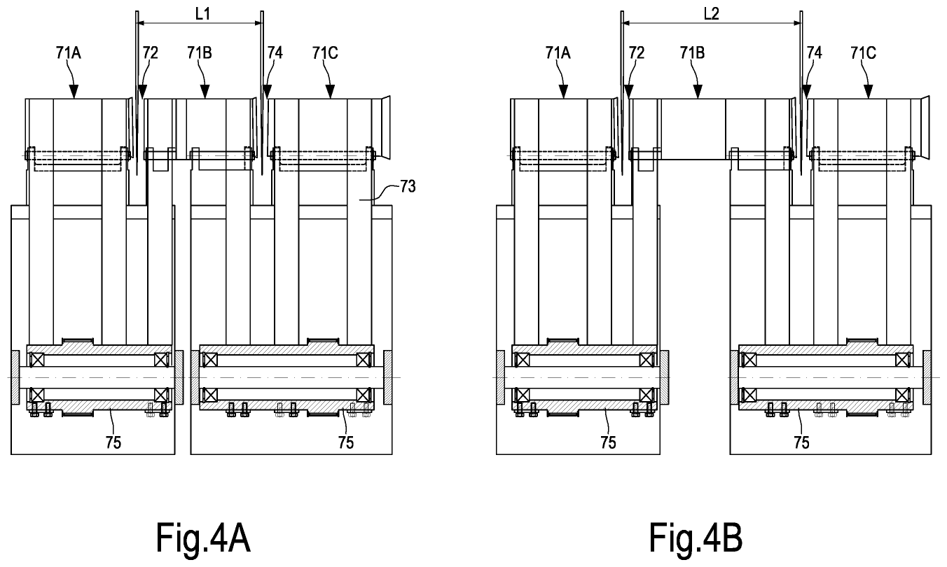

As shown in particular in the two FIGS. 4A and 4B, the three holding members 71A, 71B, 71C can take different positions with respect to one another, in that the intermediate holding member 71B has an adjustable length, i.e. it is configured like a telescopic member. In FIG. 4A, the intermediate holding member 71B is adjusted at the minimal length, so that the gaps or passages, labeled 72 and 74, defined between the holding members 71A, 71B and between the holding members 71B and 71C are at a first minimal reciprocal distance L1. In FIG. 4B the intermediate holding member 71B is elongated and the gaps 72, 74 are at a maximal reciprocal distance L2. The reciprocal distance L1, L2 between the gaps is defined based on the axial dimensions that the rolls 9 produced by cutting the logs 7 shall have. In some embodiments, the positions of the three holding members 71A, 71B, 71C can be automatically adjusted by means of linear motors or other suitable systems, through the central control unit 21, according to the type of product to be realized and, therefore, to the cut length.

The adjustment of the reciprocal distance in axial direction (i.e. parallel to the axis A-A) of the two disc-shaped cutting blades 37 and 39 may be obtained with any suitable elongation mechanism or system. In FIG. 5 a possible embodiment of the arms 33 and 35 is illustrated, allowing to adjust the reciprocal distance of the arms in axial direction and therefore the reciprocal distance of the disc-shaped cutting blades 37 and 39. It should be understood that this configuration is only one of the possible embodiments of the rotating unit 25.

More in particular, in the embodiment of FIG. 5 the arm 35 is integral with the hollow drive shaft 41 and has, at the side opposite the hollow drive shaft 41, a projection 81 with a grooved profile 83, engaging a grooved ring 85 integral with the arm 33. The grooved profile 83 and the grooved ring 85 are part of an elongation mechanism. The projection 81 and the ring 85 are torsionally coupled, so that the rotation of the hollow drive shaft 41 is transmitted to both the arm 35 and the arm 33. The grooved profiles coupled together may allow the arm 33 to slide parallel to the axis A-A and, therefore, to adjust the distance, in axial direction, between the arms 33 and 35 and consequently the distance in axial direction between the disc-shaped cutting blades 37 and 39. The adjustment can be done manually and suitable fastening members, for instance screw members, can be provided to lock the arm 33 in the desired axial position along the grooved projection 81. In other embodiments, as illustrated in FIG. 5, an actuator 91 may be provided, for example an electronically controlled electric motor, controlling the rotation of the threaded bar 93 inserted in a nut screw 95 integral with the arm 33. Alternatively, the actuator 91 can be mechanically coupled to the arm 33 by means of any other transmission system, for example a pinion-rack system, or a cylinder-piston actuator can be provided, or any other linear actuator. The actuation of the actuator 91, for example controlled by the central control unit 21, makes the arm 33 translate into the desired position with respect to the arm 35 in the axial direction A-A.

Devices for adjusting the angular offset of the two disc-shaped cutting blades 37 and 39 may be also provided. For example, each of the two disc-shaped cutting blades 37, 39 can be supported on a slide mounted on a respective arm 33, 35, movable along a guide centered with respect to the axis A-A. The slide can be positioned in the suitable position along the guide, and locked there, for example by means of a fastening screw system.

FIG. 5 also shows a possible embodiment of the members for transmitting motion from the drive shaft 51 to the disc-shaped cutting blades 37 and 39. In this embodiment, on the drive shaft 51 pulleys 93 and 94 are keyed, around which belts 97 and 99 are driven, which extend along the arms 33 and 35 and are further driven around pulleys (not shown) coaxial with the disc-shaped cutting blades 37 and 39 and torsionally constrained therewith. It is also possible to provide the transmission from the shaft 51 to the disc-shaped cutting blades 37 and 39 in a different way, for example with a series of gears, with pairs of conical wheels and a transverse shaft, or in any other suitable manner.

With the cutting machine 1 describe above it is possible to perform two cuts of the log 7 for every rotation of the rotating unit 25. As the two disc-shaped cutting blades 37 and 39 are offset by an angle smaller than 180°, there is a relatively long time between a cutting operation and the following one, during which both the disc-shaped cutting blades 37 and 39 are clear of the log 7, and during which it is possible to move the log 7 forward to position it correctly for the following cut. This time, longer than that available in the prior art cutting machines, where the disc-shaped cutting blades are offset by 180° from each other around the rotation axis of the rotating unit, allows to make the machine operate with lower accelerations of the logs 7 in the feed path 5, i.e. it allows to rotate the rotating unit 25 at a greater speed without the need for using too high accelerations for moving forward the logs between two consecutive cuts. As more time is available between two pairs of cuts, it is possible to increase the rotation speed of the rotating unit 25, thus increasing the machine productivity without increasing the mechanical stress and without accelerating the logs 7 too much.

As the two disc-shaped cutting blades 37 and 39 are angularly offset with respect to each other, they penetrate at different times through each log 7, which advance along the channels 11 of the feed path 5. In this way, at every rotation of the rotating unit 25 two cuts of each log 7 are performed, that are however temporarily staggered, so that there is no excessive compression of the product during cutting.

According to some embodiments, the angular offset (angle α) between the two disc-shaped cutting blades 37 and 39 may be such that the second disc-shaped cutting blade (for example the disc-shaped cutting blade 39) penetrates the log 7 when the first disc-shaped cutting blade (for example the disc-shaped cutting blade 37) has completely exited the log 7. In other embodiments, the angular offset can be such that both disc-shaped cutting blades 37 and 39 are engaged in the same log 7 for a given time interval and, therefore, for a given cutting angle. However, the angular offset can be chosen so that the second disc-shaped cutting blade penetrates the tubular winding core of the respective log 7 after the first disc-shaped cutting blade has exited from it. In this way the tubular winding core is not pressed in axial direction by both the disc-shaped cutting blades 37 and 39 contemporaneously.

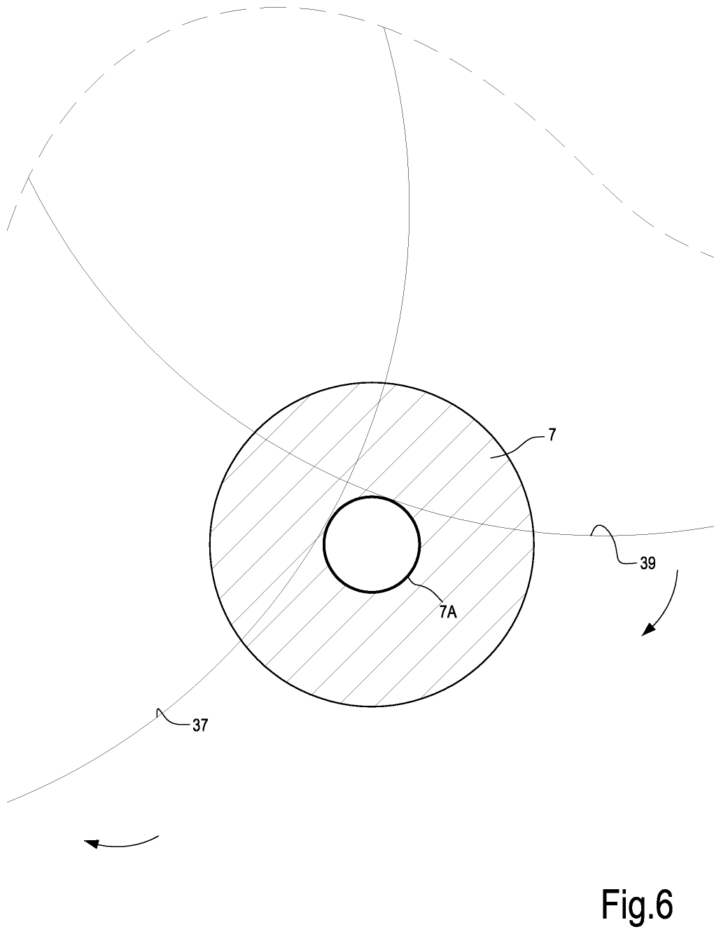

FIG. 6 schematically illustrates this concept. In the example shown in this figure, it is assumed that the rotating unit 25 rotates clockwise and therefore the disc-shaped cutting blades 37 and 39 move according to the arrows indicated in FIG. 6. The disc-shaped cutting blade 37 is the first cutting the log 7 and, in the instant shown in FIG. 6, it is exiting from the section of the log 7. The cutting edge of the disc-shaped cutting blade 37 has already passed beyond the tubular winding core 7A of the log 7. The second disc-shaped cutting blade 39 has started cutting the log 7 along the respective cutting plane, but it is in such a position that it has not yet involved the tubular winding core 7A. In this way, there is always only one of the two disc-shaped cutting blades engaging the area of the tubular winding core 7A.

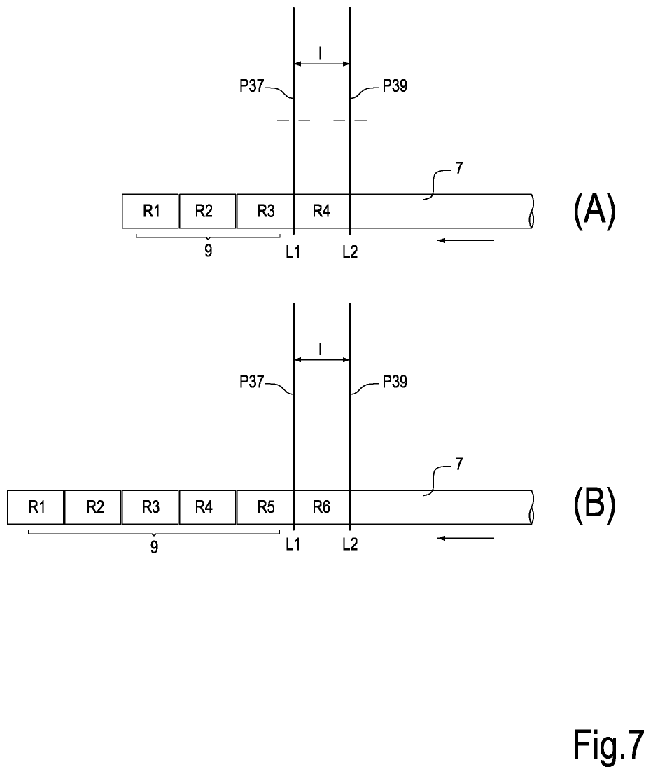

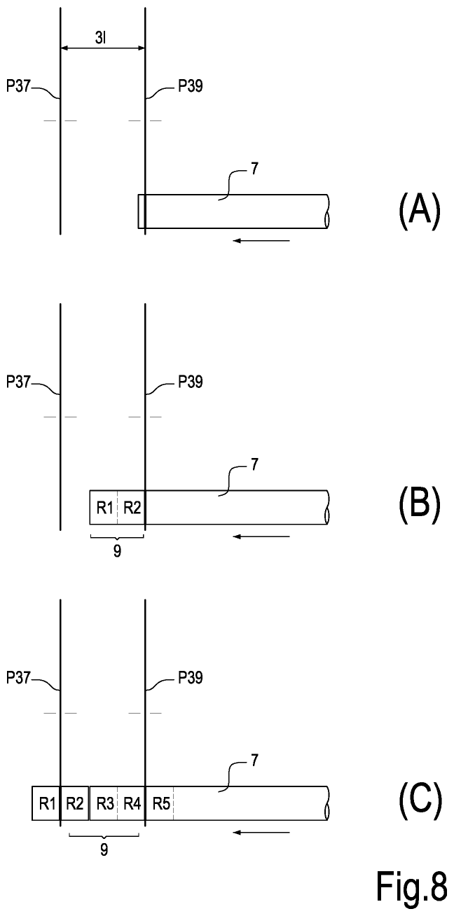

FIGS. 7 and 8 show, just by way of example, the operation of the cutting machine 1 when producing rolls of kitchen towels (FIG. 7) and rolls of toilet paper (FIG. 8). The rolls of FIG. 7 have an axial length greater than that of the rolls of FIG. 8.

In FIG. 7 the two cutting planes of the two disc-shaped cutting blades 37 and 39 are indicated. The cutting planes are indicated with P37 and P39. They substantially represent the planes on which the two disc-shaped cutting blades 37 and 39 lie and orbitally move. The two cutting planes are arranged at a distance “1” equal to the height, i.e. the axial dimension of the rolls 9 to be produced by cutting the log 7. In this way, at every rotation of the rotating unit 25 around the rotation axis A-A, two cuts of the log 7 are performed, between which a roll 9 is formed. In FIGS. 7A, 7B two subsequent spaced steps of a complete rotation of the rotating unit 25 are indicated. The produced rolls are sequentially numbered R1, R2, R3 . . . R6.

The sequence of FIGS. 8A, 8B, 8C shows the start of cutting a log 7 for producing rolls 9 of toilet paper having an axial length lower than that of the rolls 9 produced with the arrangement of the disc-shaped cutting blades 37 and 39 shown in FIG. 7. In FIG. 8 the planes P37 and P39, where the disc-shaped cutting blades 37 and 39 lie, are arranged at a distance equal to 31, where “l” is the axial length of the single roll 9 to be cut. In FIG. 8A the cut of a trimming R is shown. FIG. 8B shows the position taken by the log 7 when the subsequent cut is performed, i.e. after a rotation of the rotating unit 25. The log 7 is moved forward by two steps, i.e. by a length 21. In this cycle, the disc-shaped cutting blade 37 does not perform a cut, whilst the disc-shaped cutting blade 37 performs a cut of the log 7 at a distance equal to twice the axial length “l” of the rolls 9 to be produced.

FIG. 8C shows the following step, where the log 7 to be cut is moved forward by two more steps. In this step, through a further rotation of the rotating unit 25, the disc-shaped cutting blade 37 performs the cut that divides the first roll R1 from the second roll R2, whilst the disc-shaped cutting blade 39 performs the cut that divides the fourth roll R4 from the fifth roll R5. The cut dividing the rolls R3 and R4 will be performed at the following passage of the disc-shaped cutting blade 37.

In view of the above description it is understood that, thanks to the particular configuration of the cutting machine 1, with the two disc-shaped cutting blades 37 and 39 axially and angularly offset, it is possible to perform the cut quickly, with high productivity, significantly reducing the compression stress of the material of which the product is made (in this specific case the logs 7) due to the effect of the thickness of the disc-shaped cutting blades penetrating it.

As mentioned above, when the cutting machine 1 has a plurality of parallel channels 11, the logs 7 to be cut can be moved along the single channels 11 in staggered manner, so that when the two disc-shaped cutting blades 37 and 39 have finished cutting the first log met along the circular forward trajectories, and they are cutting the following logs, the first log 7 can start moving forward so as to be positioned correctly for the subsequent cut. Substantially, the forward movement of the logs 7 in the feed channels 11 occurs, in this case, in a sequential and temporarily staggered manner, starting the forward movement as quickly as possible, i.e. as the single log 7 is no more interested by the action of the disc-shaped cutting blades 37 and 39. In this way the time available for cutting the log 7 is increased. The offset forward movement of the logs 7 is possible, for example, by using the motors 19 separate, one for each feed channel 11.

Through the central control unit 21 it is possible to select the desired product so that the cutting machine is automatically configured to perform the desired cutting length. In particular, the axial offset between the disc-shaped cutting blades 37 and 39 can be automatically adjusted and, if necessary, also the angular offset (i.e. the angle α) around the axis A-A. Analogously, the holding members 71A, 71B, 71C take the reciprocal positions adequate for the right cutting length.

Whilst in the above description, it has been assumed that the logs 7 move forward in an intermittent way and the cutting head 23 has a fixed position in the direction of the rotation axis A-A, in other embodiments the cutting head 23 may be provided with a reciprocating movement parallel to the feeding direction of the logs 7 to be cut along the feed path 5. In this case, the cut can be performed whilst the log(s) 7 continue moving forward, if necessary at reduced speed, along the feed path 5. During cutting, i.e. whilst the disc-shaped cutting blades 37, 39 are engaged in the log(s) 7 to be cut, the cutting head 23 moves forward at the same speed as the logs 7. In the time interval during which the disc-shaped cutting blades 37 and 39 do not interact with the log(s) 7 to be cut, the cutting head 23 can move backward returning to an initial position. In this way, the cut of the logs 7 is faster and more uniform, as the logs are never completely stopped. Cutting machines provided with this function are known and disclosed in some prior art documents cited in the introductory part of the present description.

1-21. (canceled)

22. A cutting machine for cutting elongated products, comprising:
at least one feed path for the elongated products wherein the elongated products move forward along a direction substantially parallel to a longitudinal extension thereof;
feed members for feeding the elongated products, arranged along said feed path;
a rotating unit, adapted to rotate around a rotation axis and carrying at least a first disc-shaped cutting blade and a second disc-shaped cutting blade, rotation of the rotating unit causing an orbital movement of the first disc-shaped cutting blade and of the second disc-shaped cutting blade along trajectories intersecting the feed path;
wherein the first disc-shaped cutting blade and the second disc-shaped cutting blade are offset from each other in a direction parallel to the feed path; and the first disc-shaped cutting blade and the second disc-shaped cutting blade are angularly offset from each other with respect to the rotation axis of the rotating unit.

23. The cutting machine of claim 22, wherein the first disc-shaped cutting blade and the second disc-shaped cutting blade are offset from each other by an angle of less than 180°.

24. The cutting machine of claim 22, wherein the first disc-shaped cutting blade and the second disc-shaped cutting blade are offset from each other by an angle comprising between 5° and 120°.

25. The cutting machine of claim 22, wherein the offset of the first disc-shaped cutting blade from the second disc-shaped cutting blade in a direction of the feed path is adjustable.

26. The cutting machine of claim 22, wherein the offset of the first disc-shaped cutting blade from the second disc-shaped cutting blade is adjustable.

27. The cutting machine of claim 22, wherein the first disc-shaped cutting blade and the second disc-shaped cutting blade are carried by a first arm and by a second arm, respectively; wherein the first arm and the second arm are rotatable integrally with each other around the rotation axis of the rotating unit; and wherein the first arm and the second arm are coupled together by an elongation mechanism transmitting rotation between the first arm and the second arm and allowing varying of distance between the first arm and the second arm parallel to the rotation axis.

28. The cutting machine of claim 27, comprising a first drive shaft for driving the first disc-shaped cutting blade and the second disc-shaped cutting blade into rotation, said first drive shaft being supported in the first arm and in the second arm; wherein a first transmission transmits rotation from the first drive shaft to the first disc-shaped cutting blade along the first arm and a second transmission transmits rotation from the first drive shaft to the second disc-shaped cutting blade along the second arm.

29. The cutting machine of claim 28, wherein the first drive shaft is supported inside a hollow second drive shaft which is torsionally connected to the first arm and/or to the second arm.

30. The cutting machine of claim 29, comprising a first motor for driving the first drive shaft into rotation, and a second motor for driving the hollow second drive shaft into rotation.

31. The cutting machine of claim 29, wherein the hollow second drive shaft is supported in a sleeve, movable orthogonally to the feed path so as to move towards, and away from, said feed path.

32. The cutting machine of claim 22, wherein along the feed path a holding device is arranged for the elongated products adapted to hold the elongated products externally during cutting, and wherein the holding device comprises three holding members, which are arranged sequentially along the feed path, and between which two passages are provided for the first disc-shaped cutting blade and the second disc-shaped cutting blade, an intermediate holding member being arranged between an upstream holding member and a downstream holding member with respect to a feeding direction of the elongated products along the feed path.

33. The cutting machine of claim 32, wherein distance between the two passages is adjustable.

34. The cutting machine of claim 32, wherein length of the intermediate holding member in the feeding direction is adjustable.

35. The cutting machine of claim 22, wherein the feed path comprises a plurality of adjacent channels along which a plurality of the elongated products are fed.

36. The cutting machine of claim 35, wherein the feed members are adapted to feed said plurality of the elongated products, that are adjacent and parallel to one another, offset from one another.

37. The cutting machine of claim 22, comprising a central control unit adapted automatically to set distance between the first disc-shaped cutting blade and the second disc-shaped cutting blade in a direction parallel to the feed path, and/or the offset of the first disc-shaped cutting blade from the second disc-shaped cutting blade; and wherein said central control unit is also adapted automatically to set arrangement of the holding members for the elongated products to be cut according to the distance between the first disc-shaped cutting blade and the second disc-shaped cutting blade.

38. The cutting machine of claim 22, wherein the first disc-shaped cutting blade and the second disc-shaped cutting blade are angularly offset by such an angle that, for at least one portion of the orbital movement thereof, both the first disc-shaped cutting blade and the second disc-shaped cutting blade are engaged in elongated products to be cut.

39. The cutting machine of claim 22, wherein the first disc-shaped cutting blade is supported by a first arm provided with a first counterweight and the second disc-shaped cutting blade is supported by a second arm provided with a second counterweight.

40. The cutting machine of claim 22, including only said first disc-shaped cutting blade and said second disc-shaped cutting blade.

41. A method for cutting first products having a first length into second products having a second length, the first length being greater than the second length, the method comprising steps as follows:
moving forward at least one of said first products along a feed path in a feeding direction substantially parallel to a longitudinal extension of the first products;
moving a first disc-shaped cutting blade and a second disc-shaped cutting blade around a rotation axis along respective orbital trajectories intersecting the feed path, the first disc-shaped cutting blade and the second disc-shaped cutting blade being angularly offset from each other with respect to the rotation axis and the respective orbital trajectories are axially offset along the rotation axis to perform two cuts in each of the first products at every rotation of the first disc-shaped cutting blade and of the second disc-shaped cutting blade around the rotation axis.

42. The method of claim 41, wherein the first disc-shaped cutting blade and the second disc-shaped cutting blade are offset from each other by an angle of less than 180°.

43. The method of claim 41, wherein the first disc-shaped cutting blade and the second disc-shaped cutting blade are offset from each other by an angle comprising between 5° and 120°.

44. The method of claim 41, wherein the first disc-shaped cutting blade and the second disc-shaped cutting blade are axially offset from each other by a length equal to the second length of the second products, and wherein each of the first products moves forward by a step equal to twice the second length at each rotation of the first disc-shaped cutting blade and of the second disc-shaped cutting blade along the respective orbital trajectories thereof.

45. The method of claim 41, wherein the first disc-shaped cutting blade and the second disc-shaped cutting blade are axially offset from each other by a length equal to triple of the second length, and wherein each of the first products moves forward by a step equal to twice the second length at each rotation of the first disc-shaped cutting blade and of the second disc-shaped cutting blade.

46. The method of claim 41, wherein the moving forward of at least one of said first products along the feed path comprises moving forward a plurality of adjacent products along substantially parallel channels.

47. The method of claim 45, comprising moving forward said plurality of products offset from one another in the feeding direction.

48. The method of claim 41, wherein the first disc-shaped cutting blade and the second disc-shaped cutting blade are angularly offset from each other with respect to the rotation axis by such an angle that, for at least one portion of orbital motion thereof, both the first disc-shaped cutting blade and the second disc-shaped cutting blade are engaged in the products to be cut.
